(19) United States
(12) Patent Application Publication
(10) Pub. No.: US 2008/0016207 A1
(43) Pub. Date: Jan. 17, 2008

(54) Electronic driver log application with bi-directional messaging to multiple backend systems

(76) Inventor: Wesley Homer Cheng, Palo Alto, CA (US)

Correspondence Address: Bao Tran;Tran & Associates, 6768 Meadow Vista Court, San Jose, CA, 95135, US

(21) Appl. No.: 11/486,467

(22) Filed: Jul. 14, 2006

(51) Int. Cl. G06F 15/173

(52) U.S. Cl. 709/224

(57) ABSTRACT

Systems and methods are described for electronically logging a truck driver using a mobile device by collecting data using a mobile device electronic log application; sending a message from a mobile device messaging module to a server messaging module; and determining an availability of a target enterprise computer, and if the target enterprise computer is unavailable, rolling back an update to the target computer and restoring the message in the server messaging module.

### BACKGROUND

The present invention relates to electronic logging of driver work flow.

Truck drivers across the United States presently operate under regulations promulgated by the Department of Transportation (DOT) and the Federal Motor Carrier Safety Administration (FMCSA). The DOT and FMCSA regulate many aspects of the transportation industry ranging from vehicle maintenance to substance abuse. One of the more important areas that the DOT and FMCSA monitor is the occurrence of truck-related accidents and ways to reduce the number of such accidents.

To ensure compliance with safety regulations, FMCSA requires drivers to keep detailed written records of the number of hours: (1) driving; (2) on-duty not driving; (3) resting, and; (4) off-duty. Drivers must provide daily updates into a logbook carried with the driver, detailing the number of hours spent in each of the four categories mentioned above. Other information may be required as well, such as the location of where the log book entry occurred, a vehicle identification number, the name of the nearest city at the time of a logbook entry, and so on. A driver must make entries into the log book each time the driver: (1) begins driving; (2) stops driving; (3) starts or ends an “on-duty not driving” period, and; (4) starting or ending a period of rest. Drivers are mandated by federal rules to chart their hours and activities every day by drawing lines on a grid in the log book and calculating the number of hours driving, on-duty not driving, resting, and off duty, over a twenty four hour period.

Federal officials periodically inspect driver logbooks at weigh stations and other locations to certify that they have been kept up-to-date by the driver, and that the driver is following the FMCSA mandated regulations. If a driver is found to be out of compliance with the FMCSA regulations, he or she will not be permitted to continue driving until the proper amount of off-duty or rest time has elapsed. This results in late deliveries to customers and general inefficiency for the driver's employer. The driver is also penalized because the mandated “rest” time affects the hours that he/she is able to work. If a number of violations occur over a given time period, substantial fines may be levied against the driver and/or employers.

To address the logging requirement, electronic driver log (e-log) applications have been developed to automate the process of manually entering data for asset management, government rules compliance, driver performance, payroll processing, among others.

U.S. Pat. No. 6,317,668 describes a system and method for automatically calculating safety-related compliance data for vehicle operators. Vehicle operators enter an identification code and status information into a mobile communication terminal located on a vehicle. The identification code and status information is generally stored in a memory located within the mobile communication device. The identification code and status information can be transmitted to a central station where it can be processed to determine compliance with safety regulations. The resulting data may be transmitted back to the vehicle upon request. In another embodiment, a processor located within the mobile communication terminal processes the identification code and status information. The resultant data may then be transmitted to the central station or presented to the vehicle operator upon request.

FIG. 1 shows typical client and server components in an e-log application. A client application (1.1) is used by the driver to enter status changes, hours, for example. A server application (1.2) collects the data via a network (1.4) and stores it into a database (1.3); it is the application of record for the data collected from the driver. A person at the company (eg. safety officer) may run database reports from the database to determine if drivers are meeting government rules and regulation, or to get payroll information. Most applications are designed to be standalone such that there is no need to update other applications.

Most large enterprises have multiple backend applications (1.5, 1.6, 1.7) to handle different functions. However, they want to provision only one simple application for the driver. The application should then distribute appropriate information to the various backend applications and receive information from them. Examples of data and backend applications include:

Global Positioning System (GPS) data for Asset Management System: these systems track where vehicles are going and optionally enforce a geo-fence that restricts drivers to certain predefined routes.

Truck data for Driver Performance Management: data from the truck computer such as speed, acceleration/deceleration, RPM can be used to rate a driver's performance.

GPS and truck data for Safety Management System: the Federal Motor Carrier Safety Administration (FMCSA) in the United States issues rules about driver safety and requires records to demonstrate compliance.

Duty status data for Time Tracking System: drivers can use the same application for keeping track of their time which is used for payroll processing.

The data from the driver application needs to be consistently committed to all backend applications or the entire system will not be copasetic. For example, if a driver log came in from the driver application and the Enterprise System 1 (1.5) was updated but Enterprise System 2 (1.6) was not due to that system being off line for a while, then Enterprise System 2 will miss out all the updates until it is brought back up again. The state of the entire system is inconsistent because Enterprise System 1 and others might be updated while Enterprise System 2 is not. When it comes back on line again, Enterprise System 2 is unable to get updated because the Server Application and Server Database do not keep a state of which systems were updated and which were not. Hence the administrator would have to determine which updates were not committed and manually commit them into Enterprise System 2. Clearly, this is not optimum. The problem gets compounded when a large customer has many enterprise systems. Sometimes, data must get from a server to the device, eg. changes in FMCSA rules. This requires a reliable method to get updates to the device. The traditional client-server architecture of FIG. 1 relies on the client to pull updates from the server. This might not be reliable as the client needs to be carefully programmed to check for updates from the server.

FIG. 2 shows another conventional approach which uses Database Synchronization. Database synchronization is done for a client database (2.2) and server database (2.3). The e-log application (2.1) reads and writes from the Client Database just as if it were the Server database. This allows the driver to continue using the application even if there is no connectivity through the network (2.4) to the server. The schema on the client is a mirror of the schema on the server database. When there is network connectivity, the client invokes a call to synchronize with the server database. It will check for newer data in the server database and update the client database with the new values. Then it reciprocates by checking for newer data in the client database updates the server database with the new values. Database synchronization is easy to implement but has some major issues. When updates are made to the same row and column of both the client and server databases, synchronization conflicts will occur that need to be manually resolved. Though this is rare for e-log applications where it is primarily used for data collection and the data is going one way from the client to the server, there might be occasions where this will happen. Data must also be synchronized to the various backend Enterprise Systems (2.5, 2.6, 2.7). Since backend Enterprise Systems will have different schemas than the Server Database (2.3), one cannot use database synchronization here. The Enterprise Systems will likely need to poll for changes in the database. There is no guarantee that the entire system will be copasetic because nothing assures that updates are being committed to the Backend Systems. Because the client must initiate an update, if an Enterprise Application has an update, it must wait until the client starts the sync operation.

### SUMMARY

Systems and methods are described for electronically logging a truck driver using a mobile device by collecting data using a mobile device electronic log application; sending a message from a mobile device messaging module to a server messaging module; and determining an availability of a target enterprise computer, and if the target enterprise computer is unavailable, rolling back an update to the target computer and restoring the message in the server messaging module.

Implementations of the above aspect may include one or more of the following. The system stores configuration and temporary data in a database on the mobile device. The mobile messaging module communicates with the server messaging module over a network. The system sends updates from the electronic logging application to the mobile messaging module for storage until a network connection is available to the server messaging module. The server messaging module transfers each message to a transaction monitor. The transaction monitor rolls back an update for each enterprise computer receiving the update if the enterprise computer is unavailable. The transaction monitor moves the message back to the server messaging module. The transaction monitor ensures that mobile device and the one or more enterprise computers are copasetic at all times. The server messaging module stops processing of a message to each unavailable enterprise computer. The server alerts an administrator to fix the unavailable enterprise computer.

In another aspect, an electronic logging system includes a mobile device having an electronic log application; and a mobile messaging module. The system includes a server adapted to communicate with the mobile device, the server having a server messaging module; and one or more enterprise computers coupled to the messaging module.

Implementations of the above aspect may include one or more of the following. A database communicates with the mobile electronic application and the mobile messaging module, the database storing configuration and temporary data. The mobile messaging module connects over a network to the server messaging module. Updates from the electronic logging application are sent to the mobile messaging module for storage until a network connection is available to the server messaging module. The server messaging module transfers each message to a transaction monitor. The transaction monitor rolls back each update for each enterprise computer receiving the update if the enterprise computer is unavailable. The transaction monitor moves the message back to the server messaging module. The transaction monitor ensures that mobile device and the one or more enterprise computers are copasetic. The server messaging module stops processing of a message to an unavailable enterprise computer. The server alerts an administrator to fix the unavailable enterprise computer.

In another aspect, systems and methods provide a dynamically updateable driver log by generating one or more application resources; generating native code to run on a mobile client device to log the driver work flow; transmitting the application resources and the native code to the mobile client device; executing the native code on the mobile client device; and dynamically updating the native code on demand.

Implementations of the above aspect may include one or more of the following. The user can edit the application resources using a resource editor and can edit the source code using an editor. The system can compile the one or more application resources and a source code. The application resources and the native code can reside on a server. The system can transmit the one or more application resources and the native code over a wide area network. The one or more application resources can be received in an application container on the mobile client device. An application updater can be used to update an application container. The application updater can access a new native code module. The application container can access an original native code module. The application updater can access a new native code module and the application container can access an original native code module in replacing the original native code module with the new code module.

In another aspect, a system to log a driver work flow includes code running on a computer to generate one or more application resources; code running on the computer to generate native code to run on a mobile client device to log the driver work flow; a network to transmit the application resources and the native code to the mobile client device; and a processor executing the native code on the mobile client device, the processor dynamically updating the native code on demand.

Implementations of the above aspect may include one or more of the following. The system includes code to edit the application resources using a resource editor. The system also includes code to edit a source code using an editor. The native code can be one or more application resources and a source code. The application resources and the native code can reside on the computer. Code can be executed to transmit the one or more application resources and the native code over a wide area network. An application container on the mobile client device receives the one or more application resources. An application updater updates an application container. The application updater accesses a new native code module and wherein the application container accesses an original native code module, wherein the mobile device replaces the original native code module with the new code module.

Advantages of the above system may include one or more of the following. The system allows devices to interoperate even though the wireless connection may be intermittent or unreliable. Enterprise systems enjoy full access to data that is coherent and synchronized. The system allows new logs to be generated and downloaded on the fly to the mobile device. Such an updatable system is convenient to use for company with large fleets that may be all over the country. The updated form allows fresh data to be collected and distributed virtually at will and allows the shipping company to be more nimble and more responsive to market forces. The system allows the fleet operator to operate at the speed of the Internet.

### BRIEF DESCRIPTION OF THE DRAWINGS

FIG. 1 shows a conventional client-server architecture.

FIG. 2 shows a conventional database synchronization architecture.

FIG. 3 shows an exemplary operating environment for electronically tracking driver logs.

FIG. 4 illustrates an exemplary message-based client-server architecture method of performing electronic driver log applications.

FIG. 5 shows an exemplary process in accordance with the present invention.

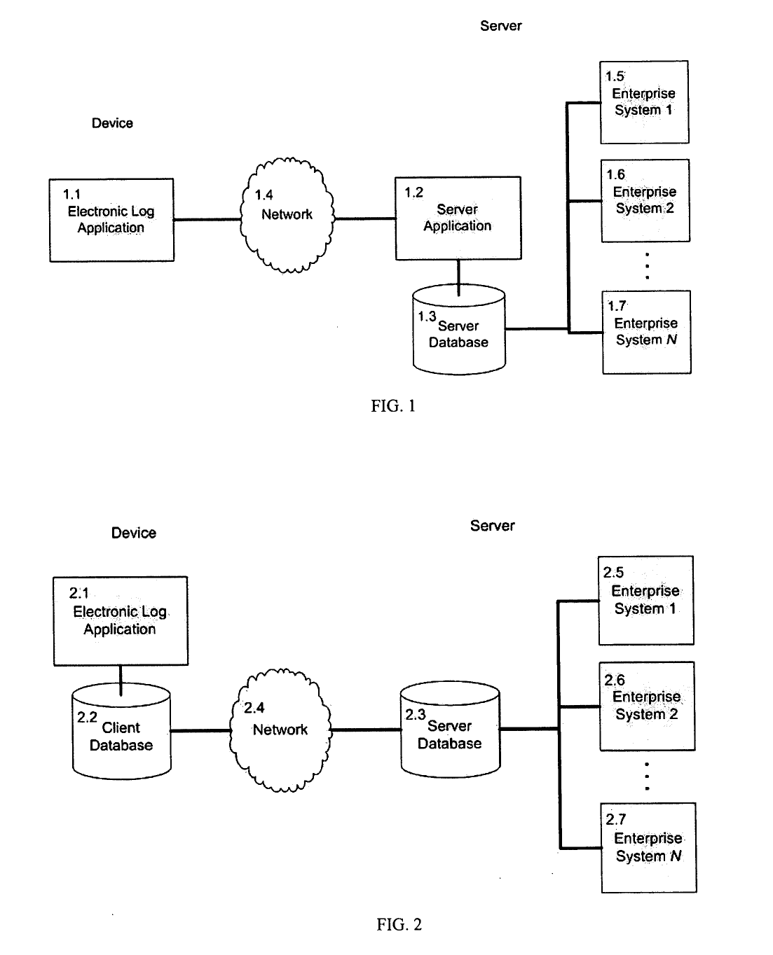

### DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

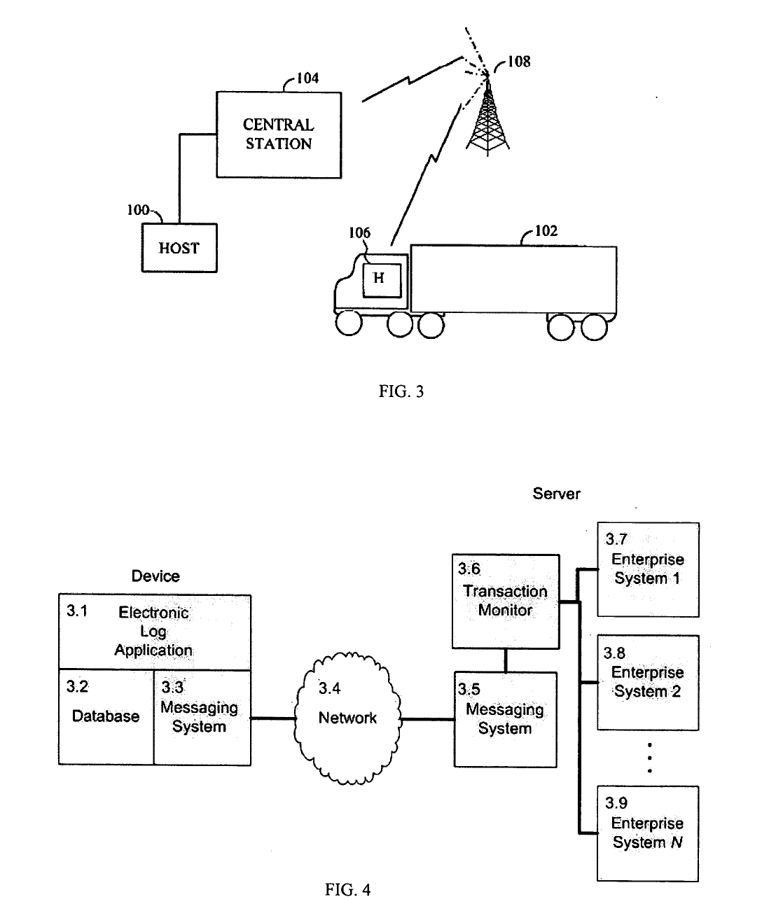

FIG. 3 is an illustration of an exemplary system supporting electronic driver logging. Information is communicated between host facility (or host) 100 and ultimately vehicle 102 in the form of voice and/or data communications. Host 100 communicates information to central station 104 using well known communication channels, such as wireline or wireless telephone channels, fiber optic channels, or the like. Host 100 is typically a freight transportation company, otherwise known as a carrier, owning a large fleet of vehicles that are widely dispersed over a large geographic area. Typically, each vehicle carries a handheld device 106 such as a smart cell phone which can act as mobile communication terminal to enable communications with host 100 by way of cellular towers 108 and central station 104. Alternative communication techniques include satellite communication or dedicated terrestrial radio stations. Although only one host 100 and one vehicle 102 is shown in FIG. 3, in practice, many hosts 100 use central station 104 to communicate information to and from their respective fleet vehicles.

The information sent by host 100 to central station 104 may contain voice or data information that is directed to one or more vehicles in the communication system. Information may also originate from central station 104 independently of host 100. In the case of information being transmitted from host 100, central station 104 receives the information and attempts to forward it to the identified vehicle or vehicles, as the case may be. The particular vehicle or vehicles for which the message is intended is identified by specifying an alpha-numeric code, typically a code corresponding to a serial number which has been pre-assigned to mobile communication terminal 106 installed on vehicle 102. However, any known method may be used to uniquely identify vehicles in the communication system.

In one embodiment, the system includes a Vehicle Interface Module (VIM). The VIM is installed in the vehicle through a plug-in SAE J1962 connector. The VIM includes a microcontroller and memory, a Bluetooth radio, and an SDIO slot for the addition of an optional Key FOB. The VIM provides full access to the vehicle's ECU data and allows the system to access Diagnostic Trouble Codes reported by the vehicle's ECU. The VIM helps users to service and maintain the vehicle with live sensor display. The VIM also reads and displays reason for Check Engine Light or MIL (Malfunction Indicator Light) which indicates presence of fault codes (DTC, Diagnostic Trouble Codes). The VIM can collect data such as Throttle position, Engine RPM, Vehicle speed, Calculated load value, Ignition timing advance, Intake air flow rate, Short term fuel trim, Long term fuel trim, Air temperature, Coolant temperature, Oxygen sensors. The VIM can also display diagnostics trouble codes (DTC), clear Check Engine lamp, retrieve and clear Generic and Manufacturer specific diagnostic trouble codes (DTC), display live sensor data and freeze frame data, and communicates with Engine Management System and Emissions Systems.

The VIM communicates with the handheld device 106, which can be a cell phone or PDA capable of running the J2ME, Windows Mobile, or BREW operating systems. The handheld device 106 is also equipped with Bluetooth and GSM/GPRS, CDMA/1X, or iDEN voice and data communications. Exemplary handheld device 106 can be the Java J2ME cell phones, Nextel i730, i850, i355, i605, Blackberry, Nextel, Verizon Wireless, Cingular, Sprint MS Windows Mobile Smartphone Edition, Nextel, Verizon Wireless, Cingular, Sprint MS Windows Mobile Pocket PC Edition, Nextel, Verizon Wireless, Cingular, Sprint BREW cell phones. The handheld device 106 runs mobile software components 108 such as a Consumer Application (CA). The CA serves as the user interface to vehicle control and configuration functions and OBDII (SAE standard for On Board Diagnostics II for cars and light trucks) data access on the VIM via Bluetooth. The CA also supports the ability to transmit the data, manually or automatically, and receive commands remotely via standard wide area wireless networks.

The VIM can run an OBDII Application Platform (OAP) or SAE J1708/J1939 Adapter (for heavy trucks) written for the VIM that accepts and responds to requests for OBDII/J1708/J1939 data and configuration settings from the consumer application. The OAP or J1708/J1939 adapter implements a range of OBDII/J1708/J1939 protocols for access to vehicle systems such as the engine, transmission, safety, and chassis. The handheld device also supports an API that enables 3rd party developers to access the VIM.

The handheld device 106 communicates with a server over a wide area network (WAN) such as the Internet. Wireless access to the Internet can be provided through cellular towers 108 that access the Internet through the cellular wireless carriers or service providers that own the towers 108.

In one embodiment, the position of vehicle 102 is provided to central station 104 at predetermined time intervals, such as once per hour, and is commonly referred to as a position report. The position of vehicle 102 may be provided generally in one of two ways. In the exemplary embodiment, the position of vehicle 102 is determined at central station 104 using a positioning unit such as GPS, GLONASS or GALILEO position receiver. These systems are well-known in the art for providing accurate, real time position information, generally in the form of latitude and longitude coordinates, to a GPS receiver located onboard vehicle 102. The position of vehicle 102 as provided by the GPS receiver is transmitted to central station 104 at predetermined intervals. The GPS information may be transmitted alone, or it may be appended to voice or text messages.

FIG. 4 shows one embodiment to provide e-log applications using a bi-directional messaging based system that ensures data consistency among all applications in the system. The system of FIG. 4 also allows updates to flow from the client or the server in real time. An e-log application (3.1) interfaces with a Database (3.2) and a Messaging System (3.3). The Database is used to store configuration and temporary data. The Messaging System connects through a Network (3.4) to the Messaging System (3.5) on the Server. Updates from the e-log application are handed off the client-side Message System (3.3) which will store the updates until a network connection is available to the server-side Messaging System (3.5). At that time, the system transfers the updates as messages to the server. The server-side Messaging System (3.5) transfers each message to the Transaction Monitor (3.6) which peels off appropriate data from the message for each of the backend Enterprise Systems (3.7, 3.8, 3.9). If any of the Enterprise Systems expecting an update is unavailable, the Transaction Monitor will roll back all the updates to previous Enterprise Systems and put the message back into the Messaging System (3.5). The entire system is thus copasetic at all times. The Messaging System will then stop processing of any messages to the Enterprise Systems and send out an alert to the administrator to fix the Enterprise System that is unavailable. Once the administrator has corrected the situation, he can tell the Messaging System to continue updating the Enterprise Systems. All this while, the Messaging System is still running and able to get updates from the client. This ensures that the devices are able to send messages to the server all the time without waiting for an Enterprise System to be available. The server-side Messaging System (3.5) stores the messages in first-in first-out (FIFO) queues so that when the Enterprise Systems are available, the messages are played to them in the same order that the devices intended.

Updates from Enterprise Systems can also be sent to the e-log application. For example, if an alert from the Asset Management System needs to be sent to the driver, the Asset Management System creates a message and sends it to the server-side Messaging System (3.5) which then forwards it on to the client-side Messaging System (3.3). The e-log application (3.1) implements an interface (in the case of the Java programming language) that is called when a message is sent from the server. It then processes the message; typically by updating the Database (3.2) and any screens in the e-log application (3.1).

The Messaging System consists of the main server (3.5) which stores all messages into persistent storage (eg. disk) so that if any part of the system goes down, the message is not lost. It implements a reliable “once and only once protocol” for handing off messages. The Messaging systems can implement several policies. The “best effort” policy states that the messaging system will make its best attempt to send a message but offers no guarantees whether the message makes it, or whether it gets delivered multiple times. The “at least once” policy will guarantee that the message gets delivered, but it might be sent multiple times; this might happen for example if an acknowledgement from the receiving end is lost but the message actually made it, so in resending the message, it gets received twice. As each message is considered a legal and binding record of a driver's activities, the strictest “one and only once” policy is preferred over the other two policies, but in certain applications, other policies can be used. The “once and only once” policy can be implemented in a manner similar to the “at least once” messaging system, where a message is re-sent until confirmed with a positive acknowledgement by the recipient. In addition, the policy keeps track of which message was sent or received by stamping each one with a unique identifier. If a positive acknowledgement was lost for some reason, the recipient will receive a duplicate from the sender but because it knows that it already received the message, it simply deletes the duplicate and sends another acknowledgement.

The Transaction Monitor (3.6) implements a two-phase commit operation similar or the same as the XA standard. This method first sets up a transaction envelope with a “begin transaction” when all Enterprise Systems are told to accept a transaction; this is the first phase. If any of the transactions fail, the previous systems will be issued a rollback command from the Transaction Monitor. If the transactions succeed, the systems are issued a commit command from the Transaction Monitor telling them that the transaction is complete. This is where the “end transaction” occurs.

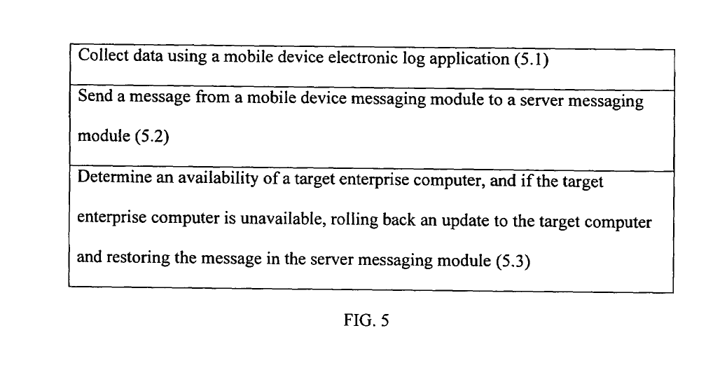

FIG. 5 shows an exemplary method to process logging data with enterprise computers and mobile devices. The process collects data using a mobile device electronic log application (5.1). Next, a message is sent from a mobile device messaging module to a server messaging module (5.2). The process determines an availability of a target enterprise computer, and if the target enterprise computer is unavailable, rolling back an update to the target computer and restoring the message in the server messaging module (5.3).

In the process of FIG. 5, the system stores configuration and temporary data in a database on the mobile device. The mobile messaging module communicates with the server messaging module over a network. The system sends updates from the electronic logging application to the mobile messaging module for storage until a network connection is available to the server messaging module. The server messaging module transfers each message to a transaction monitor. The transaction monitor rolls back an update for each enterprise computer receiving the update if the enterprise computer is unavailable. The transaction monitor moves the message back to the server messaging module. The transaction monitor ensures that mobile device and the one or more enterprise computers are copasetic at all times. The server messaging module stops processing of a message to each unavailable enterprise computer. The server can also alert an administrator to fix the unavailable enterprise computer. When the enterprise computer is operating, the process can continue the e-logging process.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

What is claimed is:

1. An electronic logging system, comprising:
a mobile device having
an electronic log application; and
a mobile messaging module; and
a server adapted to communicate with the mobile device, the server having:
a server messaging module; and
one or more enterprise computers coupled to the messaging module.

2. The system of claim 1, comprising a database coupled to the mobile electronic application and the mobile messaging module, the database storing configuration and temporary data.

3. The system of claim 1, wherein the mobile messaging module connects over a network to the server messaging module.

4. The system of claim 1, wherein updates from the electronic logging application are sent to the mobile messaging module for storage until a network connection is available to the server messaging module.

5. The system of claim 1, wherein the server messaging module transfers each message to a transaction monitor.

6. The system of claim 5, wherein the transaction monitor rolls back each update for each enterprise computer receiving the update if the enterprise computer is unavailable.

7. The system of claim 6, wherein the transaction monitor moves the message back to the server messaging module.

8. The system of claim 1, wherein the transaction monitor ensures that mobile device and the one or more enterprise computers are copasetic.

9. The system of claim 1, wherein the server messaging module stops processing of a message to an unavailable enterprise computer.

10. The system of claim 9, wherein the server alerts an administrator to fix the unavailable enterprise computer.

11. A method for electronically logging a truck driver using a mobile device, comprising:
collecting data using a mobile device electronic log application;
sending a message from a mobile device messaging module to a server messaging module; and
determining an availability of a target enterprise computer, and if the target enterprise computer is unavailable, rolling back an update to one or more enterprise computers and restoring the message in the server messaging module.

12. The method of claim 11, comprising storing configuration and temporary data in a database on the mobile device.

13. The method of claim 11, wherein the mobile messaging module communicates with the server messaging module over a network.

14. The method of claim 11, comprising sending updates from the electronic logging application to the mobile messaging module for storage until a network connection is available to the server messaging module.

15. The method of claim 11, wherein the server messaging module transfers each message to a transaction monitor

16. The method of claim 15, wherein the transaction monitor rolls back an update for each enterprise computer receiving the update if the enterprise computer is unavailable.

17. The method of claim 16, wherein the transaction monitor moves the message back to the server messaging module.

18. The method of claim 11, wherein the transaction monitor ensures that mobile device and the one or more enterprise computers are copasetic at all times.

19. The method of claim 11, wherein the server messaging module stops processing of a message to each unavailable enterprise computer.

20. The method of claim 19, wherein the server alerts an administrator to fix the unavailable enterprise computer.
